(19) United States
(12) Patent Application Publication
(10) Pub. No.: US 2024/0029098 A1
(43) Pub. Date: Jan. 25, 2024

(54) INFORMATION PROCESSING APPARATUS, METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Yuzo YAMADA, Nagoya-shi (JP); Yasunori NANYA, Nagoya-shi (JP)

(73) Assignee: TOYOTA JIDOSHA KABUSHIKI KAISHA, Toyota-shi (JP)

(21) Appl. No.: 18/353,544

(22) Filed: Jul. 17, 2023

(30) Foreign Application Priority Data
Jul. 21, 2022 (JP) 2022-116736

(51) Int. Cl. G06Q 30/0207

(52) U.S. Cl. CPC G06Q 30/0213

(57) ABSTRACT

An information processing apparatus includes a controller configured to present a plurality of options as a granting method to grant a reward based on a transaction amount by a terminal apparatus on which a plurality of settlement means can be used, the plurality of options including a first granting method that corresponds to a first settlement means used in a transaction by a user of the terminal apparatus, determine whether a reward can be granted by a second granting method selected by the user from among the plurality of options, and grant a reward by the second granting method in a case in which it is determined that a reward can be granted by the second granting method.

### CROSS-REFERENCE TO RELATED APPLICATION

This application claims priority to Japanese Patent Application No. 2022-116736 filed on Jul. 21, 2022, the entire contents of which are incorporated herein by reference.

### TECHNICAL FIELD

The present disclosure relates to an information processing apparatus, a method, and a non-transitory computer readable medium.

### BACKGROUND

Technology for granting rewards is known. A reward is something provided by a predetermined method to a user who purchases goods or services using a settlement means. The predetermined method may be recharging the balance on a particular prepaid card or accruing points for a particular credit card. For example, Patent Literature (PTL) 1 discloses technology that centralizes rewards into point accrual for a specific credit card even when payment is made with a settlement means other than the specific credit card (such as a prepaid card or debit card).

### CITATION LIST

### Patent Literature

PTL 1: JP 2002-74514 A

### SUMMARY

Known technology for granting rewards does not allow users to freely choose how to receive rewards and thus has room for improvement.

It would be helpful to improve technology related to providing rewards.

An information processing apparatus according to an embodiment of the present disclosure is an information processing apparatus including a controller configured to:

present a plurality of options as a granting method to grant a reward based on a transaction amount by a terminal apparatus on which a plurality of settlement means can be used, the plurality of options including a first granting method that corresponds to a first settlement means used in a transaction by a user of the terminal apparatus;

determine whether a reward can be granted by a second granting method selected by the user from among the plurality of options; and

grant a reward by the second granting method in a case in which it is determined that a reward can be granted by the second granting method.

A method according to an embodiment of the present disclosure is a method to be executed by an information processing apparatus, the method including:

presenting a plurality of options as a granting method to grant a reward based on a transaction amount by a terminal apparatus on which a plurality of settlement means can be used, the plurality of options including a first granting method that corresponds to a first settlement means used in a transaction by a user of the terminal apparatus;

determining whether a reward can be granted by a second granting method selected by the user from among the plurality of options; and

granting a reward by the second granting method in a case in which it is determined that a reward can be granted by the second granting method.

A non-transitory computer readable medium according to an embodiment of the present disclosure is a non-transitory computer readable medium storing a program configured to cause an information processing apparatus to:

present a plurality of options as a granting method to grant a reward based on a transaction amount by a terminal apparatus on which a plurality of settlement means can be used, the plurality of options including a first granting method that corresponds to a first settlement means used in a transaction by a user of the terminal apparatus;

determine whether a reward can be granted by a second granting method selected by the user from among the plurality of options; and

grant a reward by the second granting method in a case in which it is determined that a reward can be granted by the second granting method.

According to an embodiment of the present disclosure, technology related to providing rewards is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of an information processing apparatus;

FIG. 4 is a diagram illustrating an example of a user database;

FIG. 5 is a flowchart illustrating operations of the information processing apparatus; and

FIG. 6 is a flowchart illustrating detailed processing procedures for presenting a plurality of options.

### DETAILED DESCRIPTION

Hereinafter, an embodiment of the present disclosure will be described.

<Outline of Embodiment>

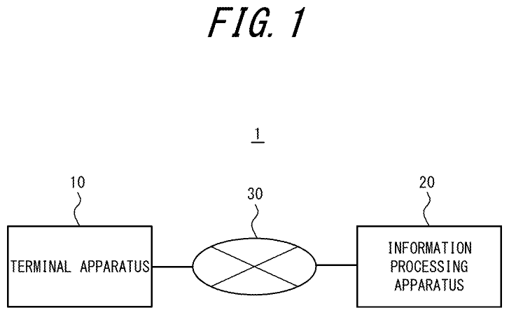

An outline of a system 1 according to an embodiment of the present disclosure will be described with reference to FIG. 1. The system 1 includes a terminal apparatus 10 and an information processing apparatus 20. The terminal apparatus 10 and the information processing apparatus 20 are communicably connected to a network 30 including, for example, the Internet, a mobile communication network, or the like.

The terminal apparatus 10 is, for example, a mobile device such as a mobile phone, a smartphone, or a tablet. A user can operate the terminal apparatus 10 and use various services on the terminal apparatus 10 via, for example, the network 30. In the present embodiment, a user can receive various rewards granted for using a settlement service on an application, of a payment means, that is installed on the terminal apparatus 10 and in which a plurality of settlement means are registered as funding sources. The various rewards include, but are not limited to, recharging the balance on a particular prepaid card and accruing points for a particular credit card. The number of terminal apparatuses 10 included in the system 1 can be freely determined.

The information processing apparatus 20 is, for example, a computer such as a server apparatus. The information processing apparatus 20 can communicate with the terminal apparatus 10 via the network 30.

First, an outline of the present embodiment will be described, and details thereof will be described later. The information processing apparatus 20 presents a plurality of options as a granting method to grant a reward based on a transaction amount by the terminal apparatus 10 on which a plurality of settlement means can be used, the plurality of options including a first granting method that corresponds to a first settlement means used in a transaction by the user of the terminal apparatus 10. The information processing apparatus 20 determines whether a reward can be granted by a second granting method selected by the user from among the plurality of options and grants a reward by the second granting method in a case in which it is determined that a reward can be granted by the second granting method.

According to the present embodiment, the granting method to grant a reward is thus determined based on selection by the user of the terminal apparatus 10. Accordingly, technology for granting rewards is improved in that users are freer to choose how to receive their rewards.

Next, configurations of the system 1 will be described in detail.

<Terminal Apparatus Configuration>

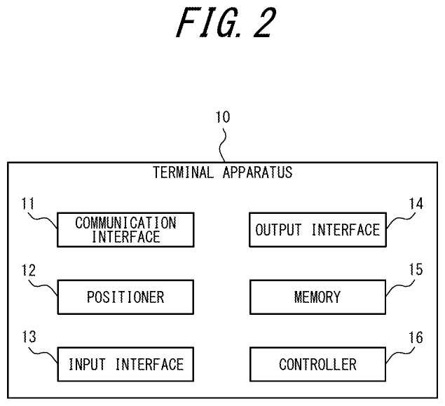

As illustrated in FIG. 2, the terminal apparatus 10 includes a communication interface 11, a positioner 12, an input interface 13, an output interface 14, a memory 15, and a controller 16.

The communication interface 11 includes at least one communication interface for connecting to the network 30. The communication interface is compliant with mobile communication standards such as the 4th generation (4G) standard or the 5th generation (5G) standard, for example, but these examples are not limiting. In the present embodiment, the terminal apparatus 10 communicates with the information processing apparatus 20 via the communication interface 11 and the network 30.

The positioner 12 includes at least one device for acquiring positional information for the terminal apparatus 10. Specifically, the positioner 12 includes a receiver corresponding to the Global Positioning System (GPS), for example, but is not limited to this and may include a receiver corresponding to any satellite positioning system.

The input interface 13 includes at least one interface for input. The interface for input is, for example, a physical key, a capacitive key, a pointing device, or a touch screen integrally provided with a display. The input interface 13 accepts an operation for inputting data to be used for the operations of the terminal apparatus 10. The input interface 13 may be connected to the terminal apparatus 10 as an external input device, instead of being included in the terminal apparatus 10. As an interface for connection, for example, an interface compliant with a standard such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The output interface 14 may include at least one output device for outputting information to notify the user of the information. The output device is a display for outputting information as images or video, a speaker for outputting information as audio, or the like, for example, but is not limited to these. The display is, for example, a liquid crystal display (LCD) or an organic electro luminescent (EL) display. The output interface 14 may include an interface for connecting to an external output device.

The memory 15 includes one or more memories. The memories are semiconductor memories, magnetic memories, optical memories, or the like, for example, but are not limited to these. The memories included in the memory 15 may each function as, for example, a main memory, an auxiliary memory, or a cache memory. The memory 15 stores any information to be used for operations of the terminal apparatus 10. For example, the memory 15 may store a system program, an application program, embedded software, and the like. The information stored in the memory 15 may be updated with, for example, information acquired from the network 30 via the communication interface 11. In the present embodiment, the memory 15 stores an application of a payment means (for example, an e-wallet application) in which a plurality of settlement means are registered as funding sources.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 16 controls the operations of the entire terminal apparatus 10.

<Information Processing Apparatus Configuration>

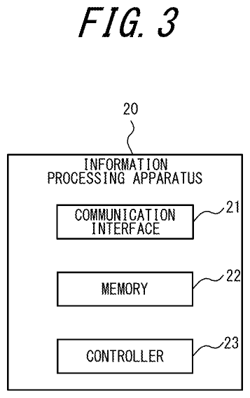

As illustrated in FIG. 3, the information processing apparatus 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the terminal apparatus 10 via the communication interface 21 and the network 30.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, and the like. The information stored in the memory 22 may be updated with, for example, information acquired from the network 30 via the communication interface 21.

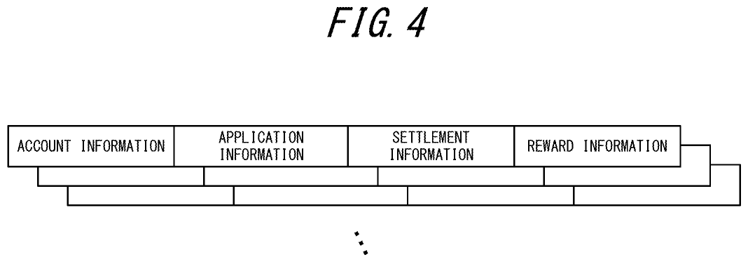

In the present embodiment, the memory 22 stores a user database. As illustrated in FIG. 4, the user database includes user data having “account information”, “application information”, “settlement information”, and “reward information” for each user of the terminal apparatus 10.

The “account information” includes any information regarding the user of the terminal apparatus 10. For example, the account information may include a login ID and a password for logging into various services, a user ID, a username, and the like, but is not limited to these. The account information may also be used to authenticate a user when a transaction is made by, for example, electronic settlement.

The “application information” includes any information that identifies an application installed on the user's terminal apparatus 10. The application is an application of a payment means (hereinafter also referred to as a “payment means application”), in which a plurality of settlement means are registered as funding sources in the present embodiment, but this example is not limiting. In the present embodiment, one payment means application is installed on the user's terminal apparatus 10, but different types of payment means applications may be installed. The application information also includes any information that identifies the applications being used on the terminal apparatus 10 (for example, running applications).

The “settlement information” includes any information used to conduct transactions such as electronic settlements. For example, the settlement information includes information on the settlement means used by the user of the terminal apparatus 10 (for example, card type, number, or expiration date) and account information. In the present embodiment, the information on the settlement means is stored in a database in association with the payment means application. In other words, information indicating which settlement means is used by the user of the terminal apparatus 10 in the payment means application is stored in the user database.

The “reward information” includes any information that indicates a reward to be granted for conducting a transaction such as electronic settlement. For example, the reward information includes information indicating a granting method to grant a reward based on the transaction amount (hereinafter simply referred to as “granting method”) for each settlement means indicated by the settlement information. The granting method includes recharging the balance and accruing points. The reward information also includes information indicating the balance, points, or point redemption rate. However, the reward information is not limited to these examples and can include any appropriate information.

The controller 23 includes at least one processor, at least one programmable circuit, at least one dedicated circuit, or a combination of these. The controller 23 controls the operations of the entire information processing apparatus 20.

<Flow of Operations of Information Processing Apparatus>

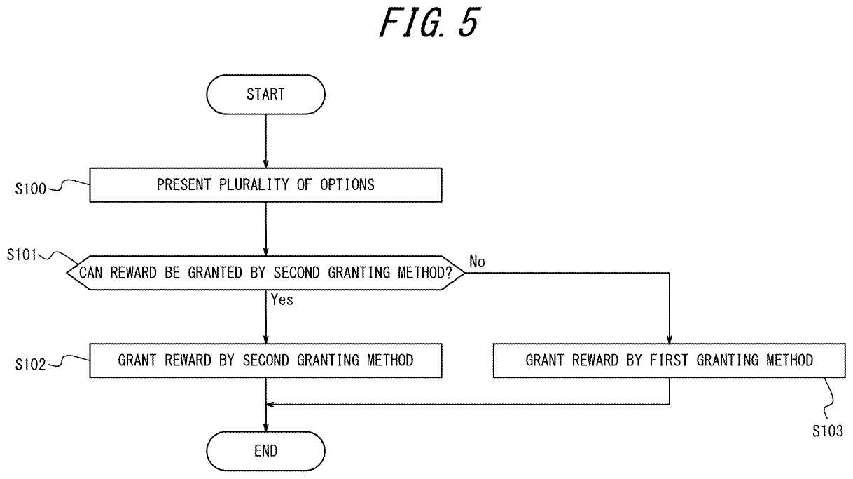

Operations of the information processing apparatus 20 according to the present embodiment will be described with reference to FIG. 5. The operations in FIG. 5 correspond to a method according to the present embodiment. The operations in FIG. 5 are performed repeatedly, for example, over a predetermined period. The predetermined period can be freely determined.

Step S100: the controller 23 of the information processing apparatus 20 presents a plurality of options as a granting method to grant a reward based on a transaction amount by the terminal apparatus 10 on which a plurality of settlement means can be used, the plurality of options including a first granting method that corresponds to a first settlement means used in a transaction by the user of the terminal apparatus 10. The “terminal apparatus 10 on which a plurality of settlement means can be used” means that the user of the terminal apparatus 10 can use the payment means application installed on the terminal apparatus 10 to select one of the settlement means and pay for the purchase of goods or services using that settlement means or recharge the balance of the settlement means. The plurality of settlement means are described below as including a prepaid card S and a credit card T, but these examples are not limiting, and any appropriate settlement means may be included. The “transaction amount by the terminal apparatus 10” is the transaction amount of the transaction conducted on the terminal apparatus 10. A “transaction” includes, but is not limited to, payment for the purchase of goods or services with the prepaid card S or the credit card T and the recharging of the balance on the prepaid card S.

Specifically, the controller 23 receives, from the communication interface 11 of the terminal apparatus 10 via the network 30 and the communication interface 21, information indicating the settlement means used in the transaction conducted by the user of the terminal apparatus 10 on the terminal apparatus 10 (hereinafter also referred to as “settlement means information”) and user identification information used to authenticate the transaction (for example, the user ID).

The controller 23 identifies the settlement means indicated by the received settlement means information as the first settlement means. For example, assume that a user operates a smartphone as the terminal apparatus 10, selects the prepaid card S on the payment means application, and makes a payment for the purchase of goods (electronic settlement). In this case, the controller 23 receives the settlement means information indicating the prepaid card S from the terminal apparatus 10 and identifies the prepaid card S as the first settlement means.

The controller 23 searches the user database using the received user identification information as a query to refer to the reward information corresponding to the user's terminal apparatus 10. The controller 23 identifies the granting method corresponding to the first settlement means indicated by a flag in the reward information as the first granting method. For example, if a flag corresponding to the prepaid card S, which is the first settlement means, indicates “recharge balance of prepaid card S”, the controller 23 identifies “recharge balance of prepaid card S” as the first granting method. Similarly for other settlement means, the controller 23 identifies the corresponding granting method for each settlement means by referring to the reward information in the user database. The controller 23 sets a plurality of granting methods thus identified as the plurality of options for the granting method to grant a reward based on the transaction amount. The controller 23 adds each of the set options to the list of options for the granting method (hereinafter also referred to as the “granting method list”). In this way, the controller 23 includes the first granting method in the plurality of options. In the present embodiment, the selectable granting methods are grouped for each settlement means, and information indicating the selectable granting methods is stored in the user database in association with each settlement means.

The controller 23 then transmits the granting method list to the terminal apparatus 10 for output, thereby presenting the plurality of options. For example, a user operates a smartphone as the terminal apparatus 10 to display a payment means application on the screen of the smartphone. In this case, the controller 23 presents the plurality of options to the user of the terminal apparatus 10 by transmitting the granting method list to the terminal apparatus 10 for display on the payment means application.

In this way, the controller 23 presents a plurality of options as a granting method to grant a reward based on a transaction amount by the terminal apparatus 10 on which a plurality of settlement means can be used, the plurality of options including a first granting method that corresponds to a first settlement means used in a transaction by the user of the terminal apparatus 10.

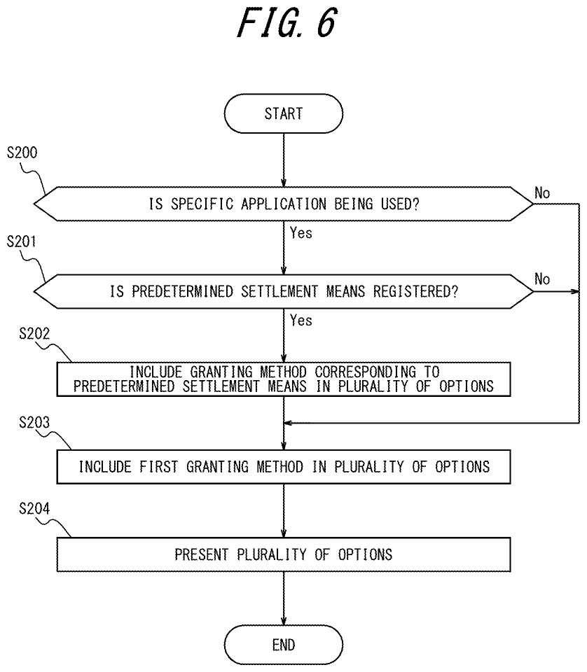

When presenting the plurality of options, the controller 23 can include the granting method corresponding to a predetermined settlement means in the plurality of options by performing the operations described in FIG. 6 below. The operations in FIG. 6 correspond to the detailed processing steps in step S100.

Step S200: the controller 23 determines whether a particular application is being used on the user's terminal apparatus 10. In other words, the controller 23 determines whether the user of the terminal apparatus has conducted a transaction using a particular application. In a case in which it is determined that a particular application is being used (step S200: Yes), the process advances to step S201. Conversely, in a case in which it is determined that a particular application is not being used (step S200: No), the process advances to step S203.

Any appropriate method can be employed for the determination of this step. For example, the controller 23 may acquire a list of applications used by the terminal apparatus 10 (hereinafter “application list”) by searching the user database to refer to the application information corresponding to the user's terminal apparatus 10. In a case in which a particular application is included in the application list, the controller 23 may determine that the particular application is being used on the user's terminal apparatus 10. For example, the particular application may be an e-wallet application provided by a particular operator.

Step S201: in a case in which it is determined that a specific application is being used (step S200: Yes), the controller 23 determines whether a predetermined settlement means is registered as the settlement means used by the specific application. In a case in which it is determined that the predetermined settlement means is registered (S201: Yes), the process advances to step S202. Conversely, in a case in which it is determined that the predetermined settlement means is not registered (S201: No), the process advances to step S203.

The predetermined settlement means may be the same settlement means as the first settlement means (i.e., the settlement means for the same granting method), but in the present embodiment, the predetermined settlement means is assumed to be a different settlement means from the first settlement means (i.e., the settlement means for a different granting method). The following explanation is based on the assumption that the first settlement means is the prepaid card S and the predetermined settlement means is the credit card T, but this example is not limiting. Any appropriate method can be employed to determine the registration of the predetermined settlement means. For example, the controller 23 may acquire a list of settlement means designated by the user as settlement means to be used in a specific application (hereinafter the “settlement means list”) by searching the user database and referring to the settlement information corresponding to the user's terminal apparatus 10. The controller 23 can determine that the predetermined settlement means is registered in a case in which the credit card T is included in the settlement means list.

Step S202: in a case in which it is determined that the predetermined settlement means is registered (Step S201: Yes), the controller 23 includes the granting method corresponding to the predetermined settlement means in the plurality of options.

Specifically, the controller 23 identifies the corresponding granting method for the credit card T, which is the predetermined settlement means, by referring to the reward information in the user database. For example, in a case in which the flag corresponding to the credit card T indicates “accrue points on credit card T”, the controller 23 identifies “accrue points on credit card T” as the granting method corresponding to the predetermined settlement means. The controller 23 sets the identified granting method (“accrue points on credit card T”) as an additional option for the granting method. The controller 23 includes the granting method corresponding to the predetermined settlement means in the plurality of options by adding the set additional choice to the granting method list.

In this way, when presenting the plurality of options, the controller 23 includes a granting method corresponding to a predetermined settlement means in the plurality of options in a case in which it is determined that a specific application is used on the terminal apparatus 10 and the predetermined settlement means is registered as a settlement means used by the specific application (step S202). On the other hand, in a case in which it is determined that a specific application is not being used on the terminal apparatus 10 (step S200: No), or in a case in which it is determined that a specific application is being used on the terminal apparatus 10 but that the predetermined settlement means is not registered as the settlement means used in the specific application (step S201: No), the process skips step S202 and advances to step S203.

In other words, users who do not use a particular application on the terminal apparatus 10, i.e., users who use other applications to conduct transactions, are not presented with the granting method corresponding to the predetermined settlement means among the plurality of options. Such users cannot select the granting method corresponding to the predetermined settlement means and cannot receive a reward by that granting method. For example, suppose that the predetermined settlement means is the credit card T. In this case, even if the user is a holder of the credit card T, the user cannot receive a reward using the granting method corresponding to the credit card T when the user uses an application other than the specific application on the terminal apparatus 10 to conduct a transaction using a settlement means other than credit card T.

On the other hand, for users who use the specific application on the terminal apparatus 10 and have registered the credit card T as the settlement means used for the specific application, the granting method corresponding to the predetermined settlement means (in this case, credit card T) is presented as the granting method to grant a reward. For the terminal apparatus 10 of a user who satisfies both conditions, the granting method corresponding to the predetermined settlement means is stored in the user database as an additional granting method that can be selected, in addition to the granting method corresponding to each settlement means. This allows users who are both credit card T holders and members of a specific application to choose to receive accrual of points on the credit card T even when conducting a transaction using a settlement means other than the credit card T (for example, the prepaid card S). Accordingly, in a case in which the point service provider of the specific settlement means is a group company that can coordinate information with the operator of the specific application, it is easier to provide an incentive to the user of the terminal apparatus 10 who is the card holder to become a member of the specific application. In a case in which the terminal apparatus 10 user who is a card holder becomes a member of a specific application, the point service provider can easily analyze the user's consumption behavior by, for example, acquiring transaction information for the terminal apparatus 10 user from a server of the operator of the specific application.

Step S203: the controller 23 includes the first granting method in the plurality of options. The process in this step is similar to the above-described process in step S100, and thus a description thereof is omitted.

Step S204: the controller 23 presents the plurality of options. The process in this step is similar to the above-described process in step S100, and thus a description thereof is omitted.

The description now returns to the flowchart in FIG. 5.

Step S101: the controller 23 determines whether a reward can be granted by the second granting method, which is the granting method selected by the user of the terminal apparatus 10 from among the plurality of options presented in step S100. In a case in which it is determined that a reward can be granted by the second granting method (S101: Yes), the process advances to step S102. Conversely, in a case in which it is determined that a reward cannot be granted by the second granting method (S101: No), the process advances to step S103.

Any appropriate method can be employed for the determination of this step. For example, the controller 23 may receive information indicating the granting method selected by the user of the terminal apparatus 10 from among the plurality of options presented in step S100 from the communication interface 11 of the terminal apparatus 10 via the network 30 and the communication interface 21. The controller 23 may identify the granting method indicated by the received information as the second granting method. The second granting method may be the same as or different from the first granting method. First and second examples are illustrated below as specific examples.

In the first example, the second granting method is the same as the first granting method. This is typically the case when the user of the terminal apparatus 10 wishes to receive a reward corresponding to the settlement means used in the transaction and chooses the same granting method as the first granting method for the second granting method. In this example, assume that the user of the terminal apparatus 10 who made an electronic settlement by the prepaid card S on an e-wallet application selected “recharge balance of prepaid card S” from among the plurality of options presented. In this case, the second granting method is the same as the first granting method. At the time of determination in this step, the transaction by the user using the first settlement means has been completed. The first settlement means is therefore not invalid due to cancellation, expiration, or other circumstances. Accordingly, the controller 23 can determine that a reward can be granted by the second granting method.

In the second example, the second granting method is different than the first granting method. This is typically the case when the user of the terminal apparatus 10 wishes to receive a reward corresponding to a settlement means that differs from the settlement means used in the transaction and chooses a different granting method than the first granting method for the second granting method. In this example, assume that the user of the terminal apparatus 10 who made an electronic settlement by the prepaid card S on an e-wallet application selected “accrue points on credit card T” from among the plurality of options presented. In this case, the second granting method is different than the first granting method. At the time of determination in this step, the transaction by the user using the first settlement means has been completed. Unlike the first example, however, the settlement means corresponding to the second granting method might be invalid due to cancellation, expiration, or other circumstances. Therefore, at the time of the determination in this step, for example, the controller 23 may query the server of the service provider for the settlement means corresponding to the second granting method as to whether the settlement means corresponding to the second granting method is valid and may then determine whether a reward can be granted by the second granting method according to the query results. The operator of the e-wallet application may act as a substitute and pay the amount of money required to grant a reward. In other words, the operator of the e-wallet application may bear the costs for paying the amount of money necessary to grant a reward corresponding to each settlement means registered in the e-wallet application. The operator of the e-wallet application could set a point redemption rate for each settlement means and convert to points according to the granting method selected by the user so as to pay the amount of money required to grant a reward. In this case, a reward can be granted to the user of the terminal apparatus regardless whether a point redemption system exists between service providers of the settlement means.

Step S102: In a case in which it is determined that a reward can be granted by the second granting method (Step S101: Yes), the controller 23 grants a reward by the second granting method. The process then ends.

Specifically, the controller 23 calculates the amount of money required to grant a reward based on the transaction amount by the settlement means, basing the calculation on the point redemption rate for the second granting method as indicated by the reward information in the user database. The controller 23 adds the calculated amount of money to the balance or points of the settlement means corresponding to the second granting method indicated by the reward information.

In the first example above, the controller 23 calculates the amount of money required to grant a reward based on the transaction amount of the electronic settlement with the prepaid card S, basing the calculation on the point redemption rate for “recharging balance of prepaid card S”, as indicated by the reward information in the user database. For example, assume that the transaction amount of electronic settlement by the user of the terminal apparatus 10 user using the prepaid card S is 10,000 yen, and the point redemption rate for the prepaid card S is 1% of the transaction amount. In this case, the controller 23 calculates 100 yen as the amount of money required to grant the reward. The controller 23 adds the calculated amount of money to the balance on the prepaid card S indicated by the reward information.

In the second example above, the amount of money required to grant a reward based on the transaction amount corresponding to the credit card T is calculated based on the point redemption rate for “accruing points on credit card T”, as indicated by the reward information in the user database. For example, assume that the transaction amount of electronic settlement by the user of the terminal apparatus 10 user using the prepaid card S is 10,000 yen, and the point redemption rate for the prepaid card S is 1% of the transaction amount. In this case, the controller 23 calculates 100 yen as the amount of money required to grant the reward. The controller 23 adds the calculated amount of money to the points on the credit card T indicated by the reward information, unlike in the first example. Here, the point redemption rate may differ between the prepaid card S, which is the settlement means corresponding to the first granting method, and the credit card T, which is the settlement means corresponding to the second granting method. In this case, the controller 23 may, in the second example, calculate the amount of money required to grant a reward according to the point conversion method set by the operator of the e-wallet application described above.

In this way, the controller 23 grants a reward by the second granting method by storing, in the user database, the value obtained by adding the amount of money calculated based on the point redemption rate of the second granting method to the balance or points of the settlement means corresponding to the second granting method.

Step S103: In a case in which it is determined that a reward cannot be granted by the second granting method (Step S101: No), the controller 23 grants a reward by the first granting method instead of by the second granting method. The process then ends.

In a case in which the second granting method is the same as the first granting method, as in the first example above, the settlement means corresponding to each granting method is the same (in this case, the prepaid card S). Problems such as cancellation of the settlement means corresponding to the second granting method therefore do not arise. Conversely, in a case in which the second granting method is different from the first granting method, as in the second example above, the settlement means are different (here, the prepaid card S and the credit card T). Problems such as cancellation of the settlement means corresponding to the second granting method (in this example, the credit card T) may therefore arise. Accordingly, in a case in which the second granting method is different from the first granting method and it is determined that a reward cannot be granted by the second granting method, the controller 23 in the present embodiment grants a reward by the first granting method instead of by the second granting method.

For example, in a case in which the above-described circumstances such as cancellation or expiration occur, the controller 23 determines that a reward cannot be granted by the second granting method and grants a reward by the first granting method instead of by the second granting method. At this time, the controller 23 may automatically switch the granting method from the second granting method to the first granting method without asking the user. The reasons are as follows. As explained in the first example above, the user of the terminal apparatus 10 often wishes to receive a reward corresponding to the settlement means used in a transaction. Put another way, transactions are often conducted using settlement means for which a desired reward can be received. Thus, the controller 23 could grant a reward using the first granting method instead of the second granting method by, for example, automatically switching the granting method from the second granting method to the first granting method without display a prompt on the terminal apparatus 10 to encourage the user to select a different granting method. This can reduce the number of steps involved in switching the granting method to grant a reward. Consequently, the process is less troublesome for the user of the terminal apparatus 10, and the burden on the administrator of the information processing apparatus 20 can be reduced. The user is preferably informed in advance that in a case in which it is determined that a reward cannot be granted by the second granting method, a reward is granted by the first granting method instead of by the second granting method.

As described above, the information processing apparatus 20 presents a plurality of options as a granting method to grant a reward based on a transaction amount by the terminal apparatus 10 on which a plurality of settlement means can be used, the plurality of options including a first granting method that corresponds to a first settlement means used in a transaction by the user of the terminal apparatus 10. The information processing apparatus 20 determines whether a reward can be granted by a second granting method selected by the user from among the plurality of options and grants a reward by the second granting method in a case in which it is determined that a reward can be granted by the second granting method.

According to such a configuration, the granting method to grant a reward is determined based on user selection. Accordingly, technology for granting rewards is improved in that users are freer to choose how to receive their rewards.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. An example of this is an embodiment in which the components of the information processing apparatus 20 are distributed between a first group of servers managed by the service provider of each settlement means and a second group of servers managed by the operator of an e-wallet application. For example, an embodiment in which some or all of the components of the information processing apparatus 20 are provided in the terminal apparatus 10 can also be implemented.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller configured to:
present a plurality of options as a granting method to grant a reward based on a transaction amount by a terminal apparatus on which a plurality of settlement means can be used, the plurality of options including a first granting method that corresponds to a first settlement means used in a transaction by a user of the terminal apparatus;
determine whether a reward can be granted by a second granting method selected by the user from among the plurality of options; and
grant a reward by the second granting method in a case in which it is determined that a reward can be granted by the second granting method.

2. The information processing apparatus according to claim 1, wherein when presenting the plurality of options, the controller is configured to include a granting method corresponding to a predetermined settlement means in the plurality of options in a case in which it is determined that a specific application is used on the terminal apparatus and the predetermined settlement means is registered as a settlement means used by the application.

3. The information processing apparatus according to claim 1, wherein the first granting method differs from the second granting method, and the controller is configured to grant a reward by the first granting method instead of the second granting method in a case in which it is determined that a reward cannot be granted by the second granting method.

4. A method to be executed by an information processing apparatus, the method comprising:
presenting a plurality of options as a granting method to grant a reward based on a transaction amount by a terminal apparatus on which a plurality of settlement means can be used, the plurality of options including a first granting method that corresponds to a first settlement means used in a transaction by a user of the terminal apparatus;
determining whether a reward can be granted by a second granting method selected by the user from among the plurality of options; and
granting a reward by the second granting method in a case in which it is determined that a reward can be granted by the second granting method.

5. A non-transitory computer readable medium storing a program configured to cause an information processing apparatus to:
present a plurality of options as a granting method to grant a reward based on a transaction amount by a terminal apparatus on which a plurality of settlement means can be used, the plurality of options including a first granting method that corresponds to a first settlement means used in a transaction by a user of the terminal apparatus;
determine whether a reward can be granted by a second granting method selected by the user from among the plurality of options; and
grant a reward by the second granting method in a case in which it is determined that a reward can be granted by the second granting method.
